(19) United States
(12) Patent Application Publication
(10) Pub. No.: US 2024/0405595 A1
(43) Pub. Date: Dec. 5, 2024

(54) ENERGY RECOVERY SYSTEM AND METHOD FOR OPERATING AN ENERGY RECOVERY SYSTEM

(71) Applicant: Eberspächer Controls Landau GmbH & Co. KG, Landau (DE)

(72) Inventors: Thomas Megerle, Birkenhoerdt (DE); Fabian Brauss, Karlsruhe (DE)

(21) Appl. No.: 18/680,774

(22) Filed: May 31, 2024

(30) Foreign Application Priority Data
Jun. 2, 2023 (DE) 10 2023 114 505.3

(51) Int. Cl. H02J 7/34; B60L 7/22; H02J 7/00; H02J 7/14

(52) U.S. Cl. CPC H02J 7/345; B60L 7/22; H02J 7/00302; H02J 7/1446; H02J 7/1492; H02J 7/1423; H02J 7/143; H02J 2207/50; H02J 2310/48

(57) ABSTRACT

An energy recovery system, in particular for a vehicle, includes at least one energy source for converting kinetic energy into electrical energy, at least one capacitor energy store, at least one energy consumer, and an actuation unit for selectively connecting the at least one energy source to the at least one capacitor energy store or the at least one energy consumer. The actuation unit is configured to connect the at least one energy source to the at least one energy consumer if the at least one energy source is in a critical energy generation operating state that overloads the at least one capacitor energy store, and to connect the at least one energy source to the at least one capacitor energy store if the at least one energy source is in a non-critical energy generation operating state that does not overload the at least one capacitor energy store.

### CROSS-REFERENCE TO RELATED APPLICATIONS

This application claims priority of German patent application no. 10 2023 114 505.3, filed Jun. 2, 2023, the entire content of which is incorporated herein by reference.

### TECHNICAL FIELD

The present disclosure relates to an energy recovery system that is used, for example, in a vehicle, and using which kinetic energy may be converted into electrical energy and stored in an energy store, and to a method for operating an energy recovery system in a vehicle, for example.

### BACKGROUND

In order to stabilize the on-board voltage, which is generally generated or maintained by one or more battery energy stores, in an on-board voltage system of a vehicle, for example an electrically operated vehicle, it is known practice to use capacitor energy stores, which are generally also referred to as SCAPs (supercapacitors), as buffer stores. Such capacitor energy stores may be charged comparatively quickly compared to battery energy stores and are able to release large amounts of energy in a short time. This makes it possible, in particular, to absorb peak loads of the on-board voltage system that last for a short time.

Such capacitor energy stores are generally configured for an operating voltage in the range of approximately 18 V, for example. The charging voltage applied to a capacitor energy store for charging should not significantly exceed the operating voltage for which a capacitor energy store is configured, in order to prevent damage to the capacitor energy store due to an overvoltage.

### SUMMARY

It is an object of the present disclosure to provide an energy recovery system and a method for operating an energy recovery system, using which it is possible, with a simple configuration, to reliably avoid overloading a capacitor energy store.

According to a first aspect of the present disclosure, this object is achieved by an energy recovery system, in particular for a vehicle, including:
at least one energy source for converting kinetic energy into electrical energy,
at least one capacitor energy store,
at least one energy consumer,
an actuation unit for selectively connecting the at least one energy source to the at least one capacitor energy store or the at least one energy consumer.

In the energy recovery system constructed according to the disclosure, the actuation unit is configured to connect the at least one energy source to the at least one energy consumer if the at least one energy source is in a critical energy generation operating state that overloads the at least one capacitor energy store, and to connect the at least one energy source to the at least one capacitor energy store if the at least one energy source is in a non-critical energy generation operating state that does not overload the at least one capacitor energy store.

In this energy recovery system, the at least one capacitor energy store may be dimensioned in such a way that it may be used to take up or store electrical energy generated by the at least one energy source in a predominantly present energy generation operating state of the at least one energy source that can be assessed as non-critical and in principle cannot cause overloading of and therefore damage to the capacitor energy store. Given that, in energy generation operating states that are potentially critical or damaging for the at least one capacitor energy store, the capacitor energy store is decoupled from the at least one energy source and the energy released therefrom is directed toward the at least one energy consumer, it is not necessary to dimension the at least one capacitor energy store so that it is also able to absorb peak loads. This contributes to a compact and cost-efficient configuration of the energy recovery system, in particular of the at least one capacitor energy store.

Although, in principle, the at least one energy source may include any system region, in particular in a vehicle, which is able to convert kinetic energy into electrical energy, in a particularly preferred configuration, the at least one energy source includes at least one of the following systems:
a drive system of an electric vehicle having at least one traction electric motor,
a power steering system of a vehicle having at least one electric steering motor,
a roll stabilization system of a vehicle having at least one stabilization electric motor.

In order to provide a comparatively large storage capacity of the at least one capacitor energy store at a sufficiently high operating voltage, the at least one capacitor energy store may include a plurality of capacitor cells connected in series with one another.

The at least one energy consumer may include at least one of the following systems:
at least one load resistor,
at least one resistance heater for dissipating heat to a heat transfer medium,
at least one latent heat accumulator,
at least one system region that is to be operated electrically and is fed from an on-board voltage system of a vehicle.

In this context, too, it should fundamentally be noted that in principle any system, which is in particular present in a vehicle, which requires electrical energy to be operated, may be used as an energy consumer. In particular, the configuration of an energy consumer for generating or storing heat is advantageous, since such systems are generally not subject to, or are less subject to, the risk of damage due to a brief overload.

A critical energy generation operating state, which may potentially also lead to damage to a capacitor energy store, may be present, for example, if at least one of the following conditions has been met:
a charging voltage generated by the at least one energy source is above a threshold charging voltage,
the at least one energy source is in an intensive recovery operating state.

The at least one energy source is, for example, in the intensive recovery operating state if at least one of the following conditions has been met:
the at least one energy source includes the at least one traction electric motor and a deceleration of the vehicle is above a threshold deceleration,
the at least one energy source includes the at least one electric steering motor and the extent of the steering interventions carried out to maintain a steering state is above a threshold extent or/and the frequency of the steering interventions carried out to maintain a steering state is above a threshold frequency,
the at least one energy source includes the at least one stabilization electric motor and the extent of the roll interventions carried out to maintain a roll state is above a threshold extent or/and the frequency of the roll interventions carried out to maintain a roll state is above a threshold frequency.

Such an intensive recovery operating state of the at least one energy source may therefore be a state for which it is fundamentally known that, when this operating state is present, it is highly likely that phases may occur, in which the potential risk of overloading a capacitor energy store may arise. As long as such an intensive recovery operating state is present, for example because a vehicle is braked intensively or, due to poor road conditions, a power steering system or a roll stabilization system is intensively active in order to maintain a specifically specified driving state, it is advantageous to keep the at least one capacitor energy store decoupled from the at least one energy source in order to thereby fundamentally exclude the risk of the capacitor energy store being overloaded.

In order to again provide the possibility of charging the at least one capacitor energy store after the transition to a state in which the at least one energy source is connected to the at least one energy consumer, in order to thereby avoid overloading the at least one capacitor energy store, the actuation unit may be configured to release the connection of the at least one energy source to the at least one energy consumer and to connect the at least one energy source to the at least one capacitor energy store if at least one of the following conditions has been met:
the at least one energy source is in a non-critical energy generation operating state,
a predetermined time period has passed since entering the critical energy generation operating state,
a charging current generated by the at least one energy source is below a threshold charging current.

According to a further aspect of the present disclosure, the object mentioned at the outset is achieved by a method for operating an energy recovery system, preferably an energy recovery system constructed according to the disclosure, the energy recovery system including:

at least one energy source for converting kinetic energy into electrical energy,
at least one capacitor energy store,
at least one energy consumer.

The method according to the disclosure includes the measures of:
a) detecting an energy generation operating state of the at least one energy source,
b) determining whether the energy generation operating state is a critical energy generation operating state that overloads the at least one capacitor energy store or a non-critical energy generation operating state that does not overload the at least one capacitor energy store,
c) connecting the at least one energy source to the at least one energy consumer if it is determined in measure b) that the energy generation operating state is a critical energy generation operating state, and connecting the at least one energy source to the at least one capacitor energy store if it is determined in measure b) that the energy generation operating state is a non-critical energy generation operating state.

It is possible to determine in measure b) that the energy generation operating state is a critical energy generation operating state if at least one of the following conditions has been met:
a charging voltage generated by the at least one energy source is above a threshold charging voltage,
the at least one energy source is in an intensive recovery operating state.

It is also possible to determine in measure b) that the at least one energy source is in an intensive recovery operating state if at least one of the following conditions has been met:
the at least one energy source includes at least one traction electric motor in an electric vehicle and a deceleration of the vehicle is above a threshold deceleration,
the at least one energy source includes at least one electric steering motor in a power steering system of a vehicle, and the extent of the steering interventions carried out to maintain a steering state is above a threshold extent or/and the frequency of the steering interventions carried out to maintain a steering state is above a threshold frequency,
the at least one energy source includes at least one stabilization electric motor in a roll stabilization system of a vehicle, and the extent of the roll interventions carried out to maintain a roll state is above a threshold extent or/and the frequency of the roll interventions carried out to maintain a roll state is above a threshold frequency.

In order to ensure sufficient charging of the at least one capacitor energy store, it is further proposed that, if the at least one energy source is connected to the at least one energy consumer in measure c), the connection of the at least one energy source to the at least one energy consumer is released again and the at least one energy source is connected to the at least one capacitor energy store if at least one of the following conditions has been met:
it is determined, when subsequently carrying out measure b) of measures a) to c) that are carried out repeatedly, that the energy generation operating state is a non-critical energy generation operating state,
a predetermined time period has passed since entering the critical energy generation operating state and connecting the at least one energy source to the at least one energy consumer,
a charging current generated by the at least one energy source is below a threshold charging current.

It should be noted that, if it is stated, in connection with the present disclosure, that at least one of several conditions has to be met in order to identify the presence of a particular condition or to take certain measures, this does not mean that the presence of each of the stated conditions is monitored. The presence or absence of each individual listed condition, or only some of the listed conditions, may be monitored without actually taking the other conditions into account in order to be able to obtain the necessary information or take the necessary measures.

### BRIEF DESCRIPTION OF DRAWING

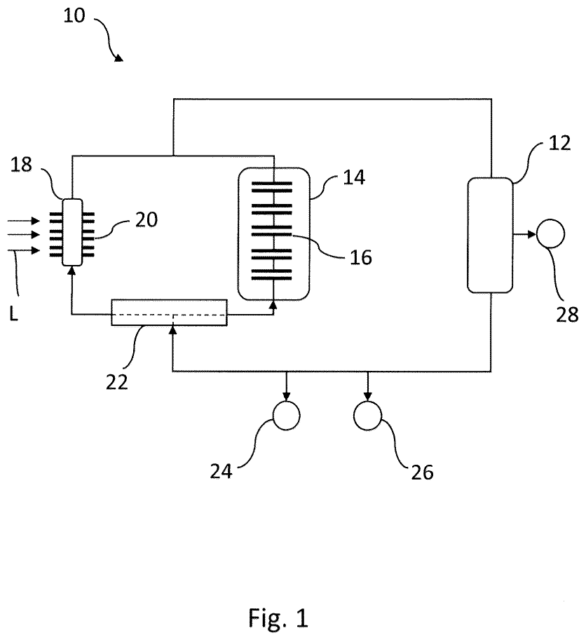

The invention will now be described with reference to the single FIG. of the drawing (FIG. 1) which shows a schematic illustration of an energy recovery system in a vehicle, for example.

### DETAILED DESCRIPTION

In FIG. 1, such an energy recovery system is generally designated by 10. The energy recovery system 10 that is used, for example, in a vehicle, in particular an electric vehicle, includes one or more energy sources 12 that are able to convert kinetic energy into electrical energy. By way of example, such an energy source 12 may include one or more traction electric motors of an electric vehicle, which, in a braking operation, convert the kinetic energy released during the deceleration of the vehicle into electrical energy in generator mode. Alternatively or in addition, such an energy source 12 may include one or more electric steering motors in a power steering system of a vehicle. These electric steering motors, which support the steering actuation, are able to convert kinetic energy, which is generated by external actions of force on steered wheels of a vehicle, into electrical energy in generator mode. Such actions can occur, for example, when a vehicle is being moved on uneven roads and the electric steering motors are operated to keep the steered wheels in the steering position specified by the steering actuation of a driver. Alternatively or in addition, such an energy source 12 may include one or more stabilizing electric motors of a roll stabilization system of a vehicle. Such a roll stabilization system is used to keep the body of the vehicle in a stable position, especially when cornering or driving on uneven terrain.

The energy recovery system 10 also includes one or more capacitor energy stores 14. Such a capacitor energy store 14 may include a plurality of capacitor cells 16 connected in series. Electrical energy generated by the energy source 12 in energy recovery mode may be routed to the capacitor energy store 14 in the form of a charging voltage applied to the capacitor energy store 14 and a charging current then flowing when voltage is applied in order to electrically charge the capacitor energy store or the capacitor cells 16 contained therein and to thereby store energy, which can be fed to an on-board voltage system of a vehicle, for example, if required.

The energy recovery system 10 also includes one or more energy consumers 18. In the configuration shown in FIG. 1, such an energy consumer 18 may include a resistance heater that is, for example, provided in the form of a load resistor or a heating conductor and generates heat when a voltage is applied and an electric current is passed through it. It is possible to dissipate this heat into air L in the region of a heat exchanger 20 including, for example, a plurality of cooling fins, such that electrical energy generated by the energy source 12 in the energy recovery system 10 is dissipated in the form of heat energy. By way of example, it is possible to use the heat absorbed in the air L to heat an interior of a vehicle when this air L is introduced into the interior.

In one alternative configuration of such an energy consumer 18, the energy consumer may be, for example, in the form of a latent heat accumulator, in which, through heating, a phase transition is brought about in a phase change material constructed on a salt or paraffin basis, for example, and energy that is subsequently able to be dissipated again, for example, to heat the air that is to be introduced into a vehicle interior can therefore be stored.

In a further alternative configuration, such an energy consumer 18 may include one or more system regions that are present in a vehicle, are to be operated electrically, and are fundamentally operated from the on-board voltage system fed from a battery, but may be fed from the energy recovery system if there is electrical energy present in the energy recovery system.

The energy recovery system 10 also includes an actuation unit 22, which is configured to selectively route the electrical energy present in the energy recovery system 10 or generated by the energy source 12 to the capacitor energy store 14 or the energy consumer 18, which means that the voltage generated by the energy source 12 is selectively applied to the capacitor energy store 14 or the energy consumer 18.

The decision as to whether the voltage generated by the energy source 12 is applied to the capacitor energy store 14 or the energy consumer 18 is made in the actuation unit 22 depending on whether the energy source 12 is in an energy generation operating state, which may lead to overloading of the capacitor energy store 14 on account of the comparatively high voltage generated and is therefore fundamentally to be regarded as critical, or is in an energy generation operating state in which the voltage generated by the energy source 12 is in such a range that does not lead to overloading of the capacitor energy store 14 and is therefore to be regarded as non-critical. If, for example, the capacitor energy store 14 is configured for an operating voltage of 18 V, a threshold charging voltage set in the actuation unit 22 as a decision criterion may be in the range of this operating voltage of approximately 18 V.

If the voltage generated by the energy source 12 in energy recovery mode is below this threshold charging voltage, the actuation unit 22 connects the capacitor energy store 14 to the energy source 12 such that the voltage generated thereby is applied to the capacitor energy store 14, and this is charged to store energy. If the voltage generated by the energy source 12 and detected by a voltmeter 24 is above the threshold charging voltage, the actuation unit 22 decouples the capacitor energy store 14 from the energy source 12 and applies the voltage generated thereby to the energy consumer 18 to dissipate the electrical energy generated in the energy recovery system in the manner described above or to use it in other areas of a vehicle.

Feeding electrical energy into the capacitor energy store 14 may also be prevented in principle if the energy source, or possibly multiple energy sources, 12 are in an intensive recovery operating state. This may be a state in which, without detecting the charging voltage by the voltmeter 24, for example, and introducing the corresponding information into the actuation unit 22 or detecting a charging current by an ammeter 26 and introducing the corresponding information into the actuation unit 22, fundamentally there is the possibility of critical operation in terms of the state of charge, and overloading of the capacitor energy store 14 could occur. By way of example, this may be an intensive braking operation of a vehicle if the vehicle is electrically operated and one or more of the traction motors are used to brake the vehicle in generator mode. Even in a state in which, for example, during movement of the vehicle on an uneven road, intense external actions on a power steering system or a roll stabilization system are present and electric steering motors or stabilization electric motors that are provided therein are operated intensively in order to keep the steering state or the roll state stable, excessively high voltages may be generated by the electric motors operating in phases in generator mode, which may lead to overloading of the capacitor energy store 14.

Such intensive recovery operating states may be identified, for example, by a sensor system 28 assigned to these various system regions. By way of example, this sensor system 28 may include one or more acceleration sensors that identify the occurrence of an excessively sharp deceleration and introduce a corresponding signal into the actuation unit 22. The sensor system 28 may contain sensors in association with a power steering system that are able to identify the steering actuation operations generated in the power steering system and in particular feed in the process information representing the extent of these steering actuation operations and the frequency of the steering actuation operations into the actuation unit 22. If there is an excessively high frequency or/and the steering actuation has an excessively high extent, this may be used as a decision criterion for the vehicle to be in such an intensive recovery operating state and therefore, as long as this state is present, the capacitor energy store 14 is to be decoupled from the energy source or the energy sources 12.

In order to return again to a state in which the electrical energy generated in the energy recovery system 10 is able to be used for charging the capacitor energy store 14 or generally for feeding system regions of a vehicle from the capacitor energy store 14 after entering such a critical energy generation operating state, which potentially leads to overloading the capacitor energy store 14 and in which the capacitor energy store 14 is decoupled from the energy source 12, the actuation unit 22 may be used, for example, if it is identified that such an intensive recovery operating state is no longer present, for example because the deceleration of a vehicle has again fallen below a critical extent or there is no longer any excessive action on a power steering system or a roll stabilization system, to terminate the coupling of the energy consumer 18 to the energy source 12 again and accordingly re-establish the coupling of the capacitor energy store 14 to the energy source 12. Since, in principle, it can be assumed that such critical energy generation operating states that lead to overloading of the capacitor energy store 14 only last for a comparatively short time, a specified time interval may be used as a further or alternative decision criterion for coupling the capacitor energy store 14 to the energy source 12, the elapsing of which time interval since entering the critical energy generation operating state, and therefore since coupling the energy consumer 18 to the energy source 12, leads to a switchover in order to couple the capacitor energy store 14 to the energy source 12 again. As a further or alternative decision criterion, the charging current detected by the current detection apparatus 26 may be taken into account, for example. If the charging current drops below a threshold charging current again after entering the critical energy generation operating state, it can be assumed that the risk of overloading the capacitor energy store 14 no longer exists, meaning that it may be coupled to the energy source 12 again.

By selectively coupling either the capacitor energy store 14 or the energy consumer 18 to the energy source 12, it becomes possible, with a comparatively simple configuration, to exclude the risk of overloading of and therefore damage to the capacitor energy store 14. The capacitor energy store may therefore fundamentally be configured for an operating voltage that is not, or is not significantly, exceeded in a normal, non-critical energy generation operating state of the energy source 12. It is therefore possible to avoid configuring the capacitor energy store 14 also for briefly occurring load peaks, which contributes to reducing the structural size and the construction costs of the capacitor energy store 14.

It is understood that the foregoing description is that of the preferred embodiments of the invention and that various changes and modifications may be made thereto without departing from the spirit and scope of the invention as defined in the appended claims.

1. An energy recovery system comprising:
an energy source for converting kinetic energy into electrical energy;
a capacitor energy store;
an energy consumer;
an actuator for selectively connecting said energy source to said capacitor energy store or to said energy consumer; and,
said actuator being configured to connect said energy source to said energy consumer when said energy source is in a critical energy generation operating state that overloads said capacitor energy store and to connect said energy source to said capacitor energy store when said energy source is in a non-critical energy generation operating state not overloading said capacitor energy store.

2. The energy recovery system of claim 1, wherein said energy source comprises at least one of the following systems:
a drive system of an electric vehicle having a traction electric motor;
a power steering system of a vehicle having an electric steering motor; and,
a roll stabilization system of a vehicle having a stabilization electric motor.

3. The energy recovery system of claim 1, wherein said capacitor energy store comprises a plurality of capacitor cells connected in series with one another.

4. The energy recovery system of claim 1, wherein said energy consumer comprises at least one of the following systems:
a load resistor;
a resistance heater for dissipating heat to a heat transfer medium;
a latent heat accumulator; and,
a system region that is to be operated electrically and is fed from an on-board voltage system of a vehicle.

5. The energy recovery system of claim 1, wherein said critical energy generation operating state is present when at least one of the following conditions has been met:
a charging voltage generated by said energy source is above a threshold charging voltage; and,
said energy source is in an intensive recovery operating state.

6. The energy recovery system of claim 2, wherein said energy source is in an intensive recovery operating state when at least one of the following conditions has been met:
said energy source comprises the traction electric motor and a deceleration of the vehicle is above a threshold deceleration;
said energy source comprises said electric steering motor and an extent of steering interventions carried out to maintain a steering state is above a threshold extent or/and a frequency of the steering interventions carried out to maintain the steering state is above a threshold frequency; and,
said energy source comprises said stabilization electric motor and an extent of roll interventions carried out to maintain a roll state is above a threshold extent or/and a frequency of the roll interventions carried out to maintain the roll state is above a threshold frequency.

7. The energy recovery system of claim 1, wherein said actuator is configured to release the connection of said energy source to said energy consumer and to connect said energy source to said capacitor energy store when at least one of the following conditions has been met:
said energy source is in the non-critical energy generation operating state;
a predetermined time period has elapsed since entering the critical energy generation operating state; and,
a charging current generated by said energy source is below a threshold charging current.

8. The energy recovery system of claim 5, wherein said energy source is in an intensive recovery operating state when at least one of the following conditions has been met:
said energy source comprises the traction electric motor and a deceleration of the vehicle is above a threshold deceleration;
said energy source comprises said electric steering motor and an extent of steering interventions carried out to maintain a steering state is above a threshold extent or/and a frequency of the steering interventions carried out to maintain the steering state is above a threshold frequency; and,
said energy source comprises said stabilization electric motor and an extent of roll interventions carried out to maintain a roll state is above a threshold extent or/and a frequency of the roll interventions carried out to maintain the roll state is above a threshold frequency.

9. The energy recovery system of claim 1, wherein the energy recovery system is for a vehicle.

10. A method for operating an energy recovery system, the energy recovery system including: an energy source for converting kinetic energy into electrical energy; a capacitor energy store; and, an energy consumer; wherein the method comprises the steps of:
a) detecting an energy generation operating state of the energy source;
b) determining whether the energy generation operating state is a critical energy generation operating state that overloads the capacitor energy store or a non-critical energy generation operating state that does not overload the capacitor energy store; and,
c) connecting the energy source to the energy consumer when there is a determination in step b) that the energy generation operating state is the critical energy generation operating state, and connecting the energy source to the capacitor energy store when there is a determination in step b) that the energy generation operating state is the non-critical energy generation operating state.

11. The method of claim 10, wherein there is a determination in step b) that the energy generation operating state is the critical energy generation operating state when at least one of the following conditions has been met:
i) a charging voltage generated by the energy source is above a threshold charging voltage; and,
ii) the energy source is in an intensive recovery operating state.

12. The method of claim 11, wherein it is determined in step b) that the energy source is in the intensive recovery operating state when at least one of the following conditions has been met:
i) the energy source includes traction electric motor in an electric vehicle and a deceleration of the vehicle is above a threshold deceleration;
ii) the energy source includes at least one electric steering motor in a power steering system of a vehicle, and an extent of steering interventions carried out to maintain a steering state is above a threshold extent or/and a frequency of the steering interventions carried out to maintain the steering state is above a threshold frequency; and,
iii) the energy source includes a stabilization electric motor in a roll stabilization system of the vehicle, and an extent of roll interventions carried out to maintain a roll state is above a threshold extent or/and a frequency of the roll interventions carried out to maintain the roll state is above a threshold frequency.

13. The method of claim 12, wherein, when the energy source is connected to the energy consumer in step c), the connection of the energy source to the energy consumer is released again and the energy source is connected to the capacitor energy store when at least one of the following conditions has been met:
there is a determination, when subsequently carrying out step b) of steps a) to c) that are carried out repeatedly, that the energy generation operating state is the non-critical energy generation operating state;
a predetermined time period has elapsed since entering the critical energy generation operating state and connecting the energy source to the energy consumer; and,
a charging current generated by the energy source is below a threshold charging current.

14. The method of claim 10, wherein the method is for operating an energy recovery system for a vehicle.
